(19) United States
(12) Patent Application Publication
(10) Pub. No.: US 2004/0230423 A1
(43) Pub. Date: Nov. 18, 2004

(54) Multiple channel mode decisions and encoding

(75) Inventors: Christos Chrysafis, Mountain View, CA (US); Siu-Leong Yu, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Divio, Inc., Sunnyvale, CA

(21) Appl. No.: 10/439,936

(22) Filed: May 16, 2003

(51) Int. Cl. G10L 19/00; G10L 21/00

(52) U.S. Cl. 704/216

(57) ABSTRACT

To select the encoding mode of an audio signal in a multi-channel system, a level of energy of the audio signal associated with each channel is determined, which in turn is used to compute a first value. Next, a second value based on a degree of correlation of the signals of each channel is determined. If the first value is smaller than the second value, the audio signal is encoded using a first encoding mode. Next, a third value defined by the energy levels and a fourth value defined by the correlation are computed. If the first value is greater than the second value, and the third value is smaller than the fourth value, the audio signal is encoded using a second encoding mode. Otherwise the audio signal is encoded using a third encoding mode.

### CROSS-REFERENCES TO RELATED APPLICATIONS

Not Applicable

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates to encoding of audio frames, and more particularly for encoding audio frames in multi-channel audio systems.

Many of the existing audio or video encoders are adapted for single channel systems. To encode audio frames associated with more than one channel, typically the same encoder is used to encode each channel separately. Often, there is strong correlation between different channels of the same audio system. Moreover, humans exhibit different sensitivities to the coding errors associated with different channels. Coding efficiency may thus be achieved if the channels are jointly coded. For example, when coding color images of a video frame, a color transformation is used to convert RGB images to YUV components. This allows bitrate reduction by coding the U and V components coarsely, i.e., using fewer bits, because humans can tolerate larger errors associated with coding of U and V components.

In the MPEG-4 audio standard, multiple audio channels may be encoded as channel pairs. For each channel pair, the left and right channels may be encoded independently, known as the LR mode of encoding. Alternatively, the left and right channels may be encoded using either mid/side coding, known as the MS mode of encoding, or using the intensity/stereo encoding, known as the IS mode of encoding. These three encoding modes may be changed for each scale-factor band. Mode selection is typically selected via a multitude of bits in the coding bitstream. By selecting different modes, coding efficiency may be improved.

Assume xₗ[i] and xᵣ[i] respectively represent the i-th sample of left and right signals of a pair of channels. For the MS mode, a 2×2 linear transformation

$$\frac{1}{2} [ \begin{matrix}1 & 1 \\ 1 & - 1\end{matrix} ]$$

is used to de-correlate xₗ[i] and xᵣ[i] to form the mid and side signals as follows:

$$\begin{matrix}{x}_{m} [ i ] = \frac{1}{2} ( {x}_{l} [ i ] + {x}_{r} [ i ] ) & ( 1 ) \\ {x}_{s} [ i ] = \frac{1}{2} ( {x}_{l} [ i ] - {x}_{r} [ i ] ) & ( 2 )\end{matrix}$$

The mid signal is the average of the left and right signals xₗ and xᵣ, and the side signal is the difference between these two signals. By performing the above transformation, a better compression is achieved if there is correlation between left signal xₗ and right signal xᵣ. If the left and right signals xₗ and xᵣ are the same, the side signal is very small (or zero) and thus requires a small number bits to encode. Furthermore, the MS coding has been shown to improve auditory perception due to its control of the noise. If there is small correlation between left and right signals xₗ and xᵣ, the quantization errors may increase as a result of the above transformation, thereby degrading the coding efficiency of the MS mode. Moreover, additional overhead bits may be required to select between LR and MS modes.

The IS mode uses the relationship between human perception of high-frequency sound components and their energy-time envelopes. Thus, in the IS mode, often only one components is transmitted, from which energy time-envelops of the other components are reconstructed with a transmitted scale factor. In a two-channel system, often only the left channel is transmitted and the right channel is reconstructed at the decoder as shown below:

xᵣ[i]=sign×is_scale×xₗ[i], (3)

where the sign bit determines the sign of xᵣ[i] with respective to xₗ[i] and the scale factor is_scale is obtained using the following equation:

$$is\_scale = {2}^{- \frac{1}{4} is\_position} \qquad ( 4 )$$

The sign and is_position are transmitted in the bitstream. The above is_position controls the scale factor is_scale. To transmit the energy envelop of the left channel, parameter is_scale is defined as:

is_scale=(Eᵣ/Eₗ)^{1/2}

Therefore:

$$is\_position = Q ( 2 {log}_{2} \frac{{E}_{l}}{{E}_{r}} ) ,$$

where Q is a quantization operator quantizing

$$2 {log}_{2} \frac{{E}_{l}}{{E}_{r}} .$$

If left and right signals are linearly dependent or approximately linearly dependent, i.e., α₁x₁[1]+αᵣxᵣ[i]≈0, the right signal can be reconstructed completely without or with small error. Since only one signal is sent and the scale factor requires small number of bits to transmit, significant coding gain can be achieved. However, if there is no correlation between left and right signals, the use of IS mode can introduce great perception distortion when hearing both reconstructed signals.

Since the coding efficiency associated with LR, MS or IS modes depends on the relationship between frames of the left and right channels, adaptively selecting which mode to be used may improve overall performance. One prior art technique is to encode the left and right channel frames using each of these three modes and select the mode which requires the fewest number of bits or the least perceptual distortion. However, because this technique requires that each audio frame be encoded three times, it is computationally inefficient.

### BRIEF SUMMARY OF THE INVENTION

In accordance with one embodiment of the present invention, to select the encoding mode of an audio signal in a multi-channel system, a level of energy of the audio signal associated with each of the channels is first determined. These energy levels are subsequently used to compute a first value. Next, a degree of correlation between the audio signals associated with each channel is determined. The correlation is subsequently used to compute a second value. If the first value is smaller than the second value, the audio signal is encoded using a first encoding mode.

Next, a third value defined by the energy levels, and a fourth value defined by the degree of correlation are computed. If the first value is greater than the second value, and the third value is smaller than the fourth value, then the audio signal is encoded using a second encoding mode. If the first value is greater than the second value, and the third value is greater than the fourth value, then the audio signal is encoded using a third encoding mode.

In some embodiments, the system includes two channels and the encoding modes from which one is selected are IS, MS and LR. In these embodiments, the first value is defined by (τ Eₗ Eᵣ) where τ is a programmable parameter defined by a user, and where energies Eₗ and Eᵣ associated with the left and right channels are defined by:

$$\begin{matrix}{E}_{l} = {\sum }_{i ∈ band} {{x}_{l} [ i ]}^{2} \\ {E}_{r} = {\sum }_{i ∈ band} {{x}_{r} [ i ]}^{2}\end{matrix}$$

where xₗ[i] and xᵣ[i] respectively represent the i-th sample of the signals of the left and right channels, and wherein said second value is defined by the square of the cross-correlation of the signals of the left and right defined by:

$$C = {\sum }_{i ∈ band} {x}_{l} [ i ] {x}_{r} [ i ]$$

and where the IS mode of encoding is selected if C² is greater than (τ Eₗ Eᵣ).

In these embodiments, the third value is defined by |Eₗ−Eᵣ|, the fourth value is defined by 2|C|, the MS mode of encoding is selected if 2|C| is greater than |Eₗ−Eᵣ|, and the LR mode of encoding is selected if 2|C| is smaller than |Eₗ−Eᵣ|.

In some embodiments, in the IS mode of encoding, the left and right channel signals xₗ₁ and xᵣ₁ are defined as following:

$$\begin{matrix}{x}_{l1} [ i ] = \{ \begin{matrix}a ( {x}_{l} [ i ] + {x}_{r} [ i ] ) & if & C > 0 \\ a ( {x}_{l} [ i ] - {x}_{r} [ i ] ) & otherwise & \end{matrix} \\ {x}_{r1} [ i ] = b {x}_{l1} [ i ]\end{matrix}$$

Parameters a and b and is_position are defined as:

$$a = \frac{1}{\sqrt{{E}_{l} + {E}_{r} + 2 \vert C \vert}} \times \sqrt{{E}_{l}} \\ b = {2}^{- \frac{1}{4} is\_position} \\ is\_position = Q ( 2 {log}_{2} \frac{{E}_{l}}{{E}_{r}} )$$

where Q is a quantization operator.

In other embodiments, in the IS mode of encoding, the left and right channel signals xₗ₁ and xᵣ₁ are defined as following:

$$\begin{matrix}{x}_{l1} [ i ] = \{ \begin{matrix}a ( {x}_{l} [ i ] + {x}_{r} [ i ] ) & if & C > 0 \\ a ( {x}_{l} [ i ] - {x}_{r} [ i ] ) & otherwise & \end{matrix} \\ {x}_{r1} [ i ] = b {x}_{l1} [ i ]\end{matrix}$$

Parameters a and b and is_position are defined as:

$$\begin{matrix}a = \frac{1}{\sqrt{{E}_{l} + {E}_{r} + 2 \vert C \vert}} \times \{ \begin{matrix}\sqrt{{E}_{r}} {2}^{\frac{1}{4} is\_position} & if {E}_{r} > {E}_{l} \\ \sqrt{{E}_{l}} & otherwise\end{matrix} \\ b = {2}^{- \frac{1}{4} is\_position} \\ is\_position = Q ( 2 {log}_{2} \frac{{E}_{l}}{{E}_{r}} )\end{matrix}$$

Some embodiments of the present invention are adapted to select between MS encoding and LR encoding of an audio signal. To encode an audio signal in these embodiments, in accordance with a first method four energy levels Eₗ₂, Eᵣ₂, Eₘₗ and Eₛ₁ defined as following are computed:

$$\begin{matrix}{E}_{l2} = {\sum }_{i ∈ band}^{} \vert {x}_{l} [ i ] \vert \\ {E}_{r2} = {\sum }_{i ∈ band}^{} \vert {x}_{r} [ i ] \vert \\ {E}_{m1} = {\sum }_{i ∈ band}^{} \vert {x}_{r} [ i ] + {x}_{r} [ i ] \vert \\ {E}_{s1} = {\sum }_{i ∈ band}^{} \vert {x}_{r} [ i ] - {x}_{r} [ i ] \vert\end{matrix}$$

where xₗ[i] and xᵣ[i] respectively are the i-th samples of the audio signal corresponding to the left and right channels. If (Eₗ₂+Eᵣ₂) is greater than

$$\frac{1}{\sqrt{2}} ( {E}_{m1} + {E}_{s1} )$$

the MS mode is selected, otherwise the LR mode is selected.

To further reduce the number of computations, energy levels F₁ and F₂ defined as following are computed:

F₁=(Eₗ₂+Eᵣ₂)

F₂=(Eₘ₁+Eₛ₁)

Accordingly, the MS mode is selected if 16×(F₁×F₂)+F₁+4×F₂ is greater than zero; otherwise the LR mode 16×(F₁−F₂)+F₁+4×F₂ is selected.

### BRIEF DESCRIPTION OF THE DRAWINGS

FIG. 1 is a flow-chart of the steps performed in selecting one of IS, MS and LR modes for encoding of audio signals, in accordance with one embodiment of the present invention.

FIG. 2 is a flow-chart of the steps performed in selecting one of IS, MS and LR modes for encoding of audio signals, in accordance with another embodiment of the present invention.

FIG. 3 is a flow-chart of steps involved in selecting one of MS and LR modes, in accordance with one embodiment of the present invention.

FIG. 4 is a flow-chart of steps involved in selecting one of MS and LR modes, in accordance with another embodiment of the present invention.

### DETAILED DESCRIPTION OF THE INVENTION

In accordance with one embodiment of the present invention, the degree of cross-correlation between corresponding audio frames of left and right channels is used, in part, to decide whether to encoded these frames in accordance with IS mode, as explained further below. Assume Eₗ represents the energy of the audio frame to be encoded by the left channel (hereinafter alternatively referred to as the left signal) and Eᵣ represents the energy of the audio frame to be encoded by the right channel (hereinafter alternatively referred to as the right signal), accordingly:

$$\begin{matrix}{E}_{l} = {\sum }_{i ∈ band}^{} {{x}_{l} [ i ]}^{2} & ( 5 ) \\ {E}_{r} = {\sum }_{i ∈ band}^{} {{x}_{r} [ i ]}^{2} & ( 6 )\end{matrix}$$

where xₗ[i] and xᵣ[i] respectively represent the i-th sample of the left and right signals.

The cross-correlation C between these two signals is defined as:

$$C = {\sum }_{i ∈ band}^{} {x}_{l} [ i ] {x}_{r} [ i ] \qquad ( 7 )$$

which when normalized is as following:

$$ρ = \frac{C}{\sqrt{{E}_{l} {E}_{r}}} \qquad ( 8 )$$

In accordance with the first aspect of the present, mode IS is selected if ρ²>τ, where τ is a decision threshold defined by the user. Combining equations (7) and (8), it is seen that the IS mode is selected if:

C²>τ EₗEᵣ (9)

In some embodiments, τ is selected to have value between 0.9 and 1.

As seen from expression (9), if C² is greater than (τ Eₗ Eᵣ), the IS mode is selected. If, however, C² is less than (τ Eₗ Eᵣ), one of LR and MS mode is selected, as described further below. Assume that G_{LR} and G_{MS} represent the coding gains achieved from using the LR and MS modes, respectively:

G_{LR}=(Eₗ+Eᵣ)/(EₗEᵣ)^{1/2} (10)

G_{MS}=(Eₘ+Eₛ)/(EₘEₛ)^{1/2} (11)

where Eₘ and Eₛ are the energies of the MS signals xₘ and xₛ respectively. Signals xₘ and xₛ are obtained using equations (1) and (2) that are repeated below:

$$\begin{matrix}{x}_{m} [ i ] = \frac{1}{2} ( {x}_{l} [ i ] + {x}_{r} [ i ] ) & ( 1 ) \\ {x}_{s} [ i ] = \frac{1}{2} ( {x}_{l} [ i ] - {x}_{r} [ i ] ) & ( 2 )\end{matrix}$$

In accordance with the present invention, mode MS is selected signals if G_{MS} is greater than G_{LR}. Using equations (10 and (2), energies Eₘ and Eₛ are as shown in the following:

$$\begin{matrix}{E}_{m} = \frac{1}{4} {\sum }_{i ∈ band}^{} {( {x}_{l} [ i ] + {x}_{r} [ i ] )}^{2} = \frac{1}{4} ( {E}_{l} + {E}_{r} + 2 C ) & ( 12 ) \\ {E}_{s} = \frac{1}{4} {\sum }_{i ∈ band}^{} {( {x}_{l} [ i ] - {x}_{r} [ i ] )}^{2} = \frac{1}{4} ( {E}_{l} + {E}_{r} - 2 C ) & ( 13 )\end{matrix}$$

By substituting equations (10 and (13) into equation (11) it is seen that:

G_{MS}=2(Eₗ+Eᵣ)/((Eₗ+Eᵣ)²−4C²)^{1/2} (14)

Thus, from equations (14) and (10), it is seen that G_{MS} is greater than G_{LR} if the following condition holds:

2|C|>|Eₗ−Eᵣ (15)

Therefore, if inequality (15) is true, in accordance with the present invention, mode MS is selected, otherwise mode LR is selected.

As is understood by those skilled in the art, the IS mode is more adapted for high frequency bands. Because the MS mode is obtained by a linear transformation, it may be selected for all frequency bands.

Generation of IS Signals

In accordance with another aspect of the present invention, right and left signals for use in the IS mode, are computed in accordance with the following:

$${x}_{l1} [ i ] = \{ \begin{matrix}a ( {x}_{l} [ i ] + {x}_{r} [ i ] ) & if & C > 0 \\ a ( {x}_{l} [ i ] - {x}_{r} [ i ] ) & otherwise & \end{matrix} \qquad ( 16 )$$

xᵣ₁[i]=bxₗ₁[i] (17)

Parameters a and b are described further below. As seen from equations (16) and (17), the right and left signals have different signs if C<0. Assume that Eₗ₁ and Eᵣ₁ represent the energy of xₗ₁[i] and xᵣ₁[i] respectively. From equations (16) and (17) it is seen that:

Eₗ₁=a²(Eₗ+Eᵣ+2|C|) (18)

Eᵣ₁=b²Eₗ₁ (19)

To determine a and b, the energy Eₗ₁ of the left signal xₗ₁ is set to equal to the energy Eₗ of signal xₗ, shown in equation (5). Similarly, the energy Eᵣ₁ of the right signal xᵣ₁ is set to equal to the energy Eᵣ of signal xᵣ, shown in equation (6). Accordingly, from equations (18)-(19) and ((5)-(6), it is seen that:

$$a = \frac{1}{\sqrt{{E}_{l} + {E}_{r} + 2 \vert C \vert}} \times \sqrt{{E}_{l}} \qquad ( 20 )$$

At the decoder, the right signal is constructed from the left signal using equation (3) that is shown again below:

xᵣ[i]=sign×is_scale×xₗ[i], (3)

Therefore:

$$b = {2}^{- \frac{1}{4} is\_position}$$

Using equations (21) and (4), it is seen that

$$is\_position = Q ( 2 {log}_{2} \frac{{E}_{l}}{{E}_{r}} ) \qquad ( 22 )$$

where Q( ) represents a quantization operation. Because of the quantization operation, the reconstructed right signal at the decoder is often not exactly equal to that obtained using equation (17).

In accordance with one aspect of the present invention, scaling factor a is selected as shown below in equation (23) so as to further reduce the total energy difference between original and new left and right signals, i.e. the quantity of |Eₗ₁+Eᵣ₁−Eₗ−Eᵣ|:

$$a = \frac{1}{\sqrt{{E}_{l} + {E}_{r} + 2 \vert C \vert}} \times \{ \begin{matrix}\sqrt{{E}_{r}} {2}^{\frac{1}{4} is\_position} & if {E}_{r} > {E}_{l} \\ \sqrt{{E}_{l}} & otherwise\end{matrix} \qquad ( 23 )$$

If there is no quantization error in computing the is_position as a result of the quantization operation, then:

$$\sqrt{{E}_{l}} = \sqrt{{E}_{r}} {2}^{\frac{1}{4} is\_position} .$$

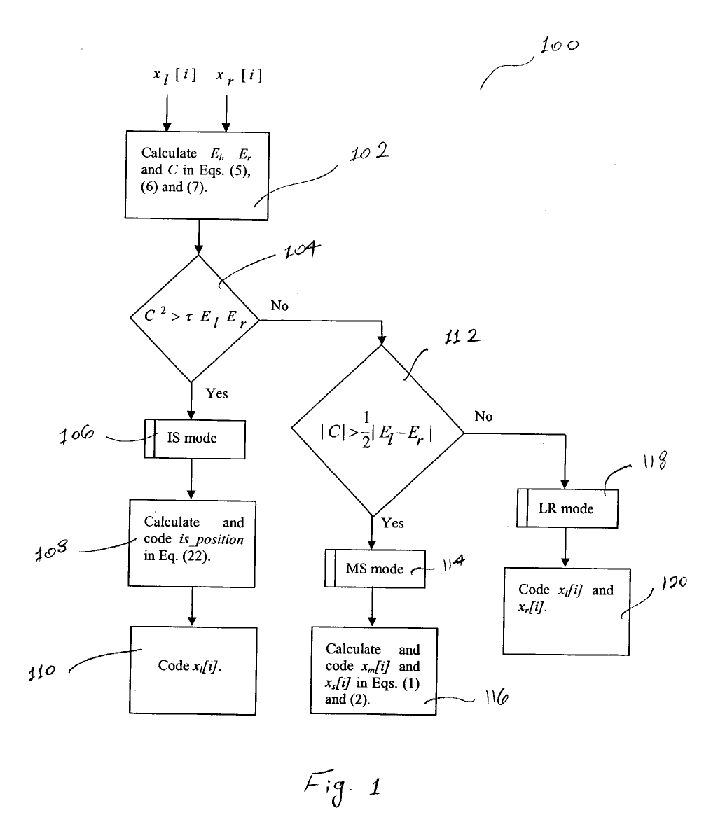

FIG. 1 is a flow-chart 100 showing the steps involved in selecting one of IS, MS and LR modes, in accordance with the present invention. In step 102, left and right signals xₗ and xᵣ are received from which energies Eₗ, Eᵣ and cross-correlation C are computed, in accordance with equations (5)-(7) described above. Next, in step 104, C² and τ Eₗ Eᵣ are computed. As seen from equation (9), If C²is greater than τ Eₗ Eᵣ, then the IS mode is selected in step 106. Next, in step 108 and using equation (22) parameter is_position is computed. Next, in step 110, the left signal xₗ is encoded.

If in step 104, C² is less than τ Eₗ Eᵣ, then the IS mode is not selected and the process moves to step 112, where 2|C| and |Eₗ−Eᵣ| are computed. If 2|C| is greater than |Eₗ−Eᵣ|, see inequality (15), then the MS mode is selected in step 114. Next, in step 116, xₘ and xₛ are encoded using equations (1) and (20 shown above. If in step 112, 2|C| is determined to be less than |Eₗ−Eᵣ|, then the LR mode is selected in step 118. Next, in step 120, xᵣ and xₗ are encoded.

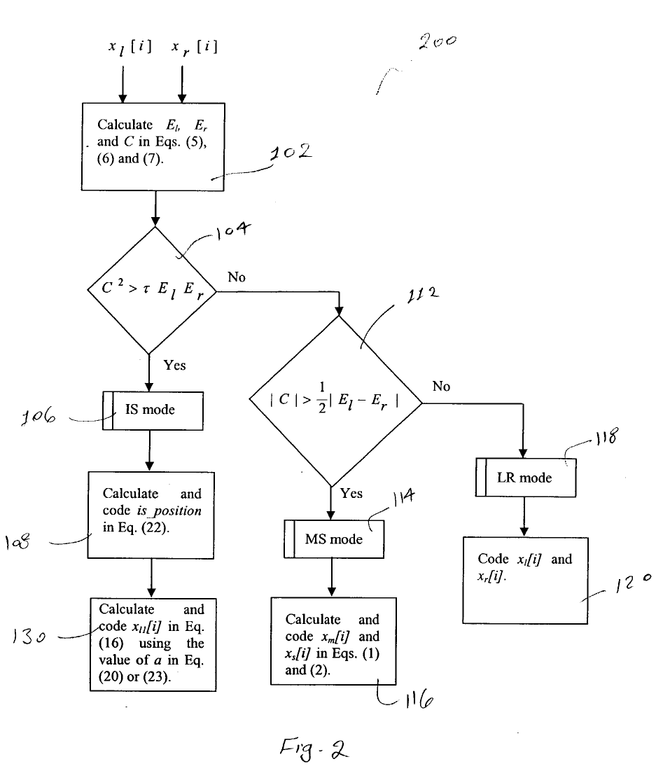

FIG. 2 is a flow-chart 200, showing the steps involved in selecting one of IS, MS and LR modes, in accordance with the present invention. Except as for step 110, flow-chart 200 is similar to flow-chart 100 and is thus not described in detail. In step 130 of flow-chart 200, after the IS mode is selected in step 106, and parameter is_position is computed in step 108, left signal xₗ₁ of the present invention and defined in equation (16), is computed using either equation (2) or equation (23).

Decision for MS and LR Modes

In some embodiments of the present invention, a decision is made to select between only the MS and LR modes. To further reduce the computations for these embodiments, by combining equations (12) and (13) it is shown that:

$${\sum }_{i ∈ band} {( {x}_{l} [ i ] + {x}_{r} [ i ] )}^{2} + {\sum }_{i ∈ band} {( {x}_{l} [ i ] - {x}_{r} [ i ] )}^{2} = 2 ( {E}_{l} + {E}_{r} ) \qquad ( 24 )$$

Accordingly, in these embodiments, the MS mode is selected if the following inequality is true:

$$( {E}_{l2} + {E}_{r2} ) > \frac{1}{\sqrt{2}} ( {E}_{m1} + {E}_{s1} ) \qquad ( 25 )$$

where energies E₁ₗ and Eₗ₂ are the energy of original signals calculated using the absolute value operators, as shown below:

$$\begin{matrix}{E}_{l2} = {\sum }_{i ∈ band} \vert {x}_{l} [ i ] \vert & ( 26 ) \\ {E}_{r2} = {\sum }_{i ∈ band} \vert {x}_{r} [ i ] \vert & ( 27 )\end{matrix}$$

In accordance with the present invention, energies Eₘ₁ and Eₛ₁ are defined as following:

$$\begin{matrix}{E}_{m1} = {\sum }_{i ∈ band} \vert {x}_{l} [ i ] + {x}_{r} [ i ] \vert & ( 28 ) \\ {E}_{s1} = {\sum }_{i ∈ band} \vert {x}_{r} [ i ] - {x}_{r} [ i ] \vert & ( 29 )\end{matrix}$$

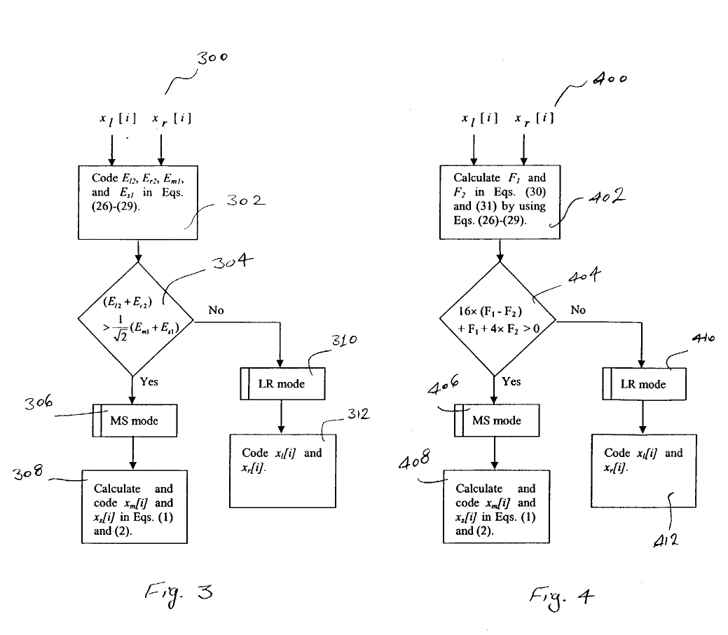

FIG. 3 is a flow-chart 300, showing the steps involved in selecting one of MS and LR modes, in accordance with the present invention, when only these two modes are available. In step 302, energies Eₗ₂, Eᵣ₂, Eₘ₁ and Eₛ₁ are computed, in accordance with equations (26)-(29). Next, in step 304, it is determined whether inequality (25) is true or false. If inequality (25) is true, the MS mode is selected in step 306. Next, in step 308, mid and sid signals xₘ and xₛ signals are computed, in accordance with equations (1) and (2). If inequality (35) is false, the LR mode is selected in step 310. Next, in step 312, left and right signals xₗ and xᵣ signals are computed.

To further reduce the computation, parameters F₁ and F₂ are defined as following:

F₁=(Eₗ₂+Eᵣ₂) (30)

F₂=(Eₘ₁+Eₛ₁). (31)

and \sqrt{2} is approximated as by 17/12 or 1.4167. Accordingly, inequality (25) used for selecting either the MS or the LR mode may be simplifies as:

16×(F₁−F₂)+F₁+4×F₂>0 (32)

Since the multiplications by 16 and 4 my be implemented in digital logic by shifting operation, determination of whether to select MS or the LR mode is simplified.

FIG. 4 is a flow-chart 400, showing the steps involved in selecting one of the MS and LR modes, in accordance with the present invention, when only these two modes are available. In step 402, energy related parameters F₁ and F₂ are computed, in accordance with equations (26)-(3 1). Next, in step 404, it is determined whether inequality (32) is true or false. If inequality (35) is true, the MS mode is selected in step 406. Next, in step 408, mid and sid signals xₘ and xₛ signals are computed, in accordance with equations (1) and (2). If inequality (35) is false, the LR mode is selected in step 410. Next, in step 412, left and right signals xₗ and xᵣ signals are computed.

It is understood that the above embodiments of the present invention may be performed entirely by software modules executed by a central processing unit. The above embodiments may also be performed by a combination of software and hardware modules. Alternatively, other embodiments may be performed entirely by dedicated hardware modules.

The above embodiments of the present invention are illustrative and not limitative. Various alternatives and equivalents are possible. Other additions, subtractions, deletions, and other modifications and changes to the present invention may be made thereto without departing from the scope of the present invention and is set forth in the appended claims.

What is claimed is:

1. A method for selecting an encoding mode of an audio signal in a multi-channel system, the method comprising:
determining energy level of audio signal associated with each of the channels;
computing a first value defined by said energy levels;
determining degree of correlation between the audio signal associated with each of the channels;
computing a second value defined by said degree of correlation; and
selecting a first mode of encoding if the first value is smaller than the second value.

2. The method of claim 1 further comprising:
computing a third value defined by said energies;
computing a fourth value defined by said degree of correlation;
selecting a second mode of encoding if the first value is greater than the second value, and the third value is smaller than the fourth value; and
selecting a third mode of encoding if the first value is greater than the second value, and the third value is greater than the fourth value.

3. The method of claim 2 wherein said multi-channel system includes two channels, wherein said first value is defined by (τ Eₗ Eᵣ) where τ is a programmable parameter and wherein energies Eₗ and Eᵣ associated with the left and right channels are defined by:
$$\begin{matrix}{E}_{l} = {\sum }_{i ∈ band} {{x}_{l} [ i ]}^{2} \\ {E}_{r} = {\sum }_{i ∈ band} {{x}_{r} [ i ]}^{2}\end{matrix}$$
where xₗ[i] and xᵣ[i] respectively represent the i-th sample of the signals of the left and right channels, and wherein said second value is defined by the square of the cross-correlation of the signals of the left and right defined by:
$$C = {\sum }_{i ∈ band} {x}_{l} [ i ] {x}_{r} [ i ]$$
and wherein the IS mode of encoding is selected if C² is greater than (τ Eₗ Eᵣ).

4. The method of claim 3 wherein said third value is defined by |Eₗ−Eᵣ| and wherein said fourth value is defined by 2|C|, wherein an MS mode of encoding is selected if 2|C| is greater than Eₗ−Eᵣ|, and wherein an LR mode of encoding is selected if 2|C| is smaller than |Eₗ−Eᵣ|.

5. The method of claim 4 wherein the left and right channel signals xₗ₁ and xᵣ₁ are defined as following if the IS mode is selected:
$${x}_{l 1} [ i ] = \{ \begin{matrix}a ( {x}_{l} ( i ) + {x}_{r} [ i ] ) & if & C > 0 \\ a ( {x}_{l} [ i ] - {x}_{r} [ i ] ) & otherwise & \end{matrix} \\ {x}_{r l} [ i ] = b {x}_{l 1} [ i ]$$
wherein said parameters a and b are defined as:
$$\begin{matrix}a = \frac{1}{\sqrt{{E}_{l} + {E}_{r} + 2 \vert C \vert}} \times \sqrt{{E}_{l}} \\ b = {2}^{- \frac{1}{4} is\_position}\end{matrix}$$
where parameter is_position is defined as:
$$is\_position = Q ( 2 {log}_{2} \frac{{E}_{l}}{{E}_{r}} )$$
and wherein Q is a quantization operator.

6. The method of claim 4 wherein the left and right channel signals xₗ₁ and xᵣ₁ are defined as following if the IS mode is selected:
$${x}_{l 1} [ i ] = \{ \begin{matrix}a ( {x}_{l} ( i ) + {x}_{r} [ i ] ) & if & C > 0 \\ a ( {x}_{l} [ i ] - {x}_{r} [ i ] ) & otherwise & \end{matrix} \\ {x}_{r l} [ i ] = b {x}_{l 1} [ i ]$$
wherein said parameters a and b are defined as:
$$\begin{matrix}a = \frac{1}{\sqrt{{E}_{l} + {E}_{r} + 2 \vert C \vert}} \times \{ \begin{matrix}\sqrt{{E}_{r}} {2}^{\frac{1}{4} is\_position} & if {E}_{r} > {E}_{l} \\ \sqrt{{E}_{l}} & otherwise\end{matrix} \\ b = {2}^{- \frac{1}{4} is\_position}\end{matrix}$$
where parameter is_position is defined as:
$$is\_position = Q ( 2 {log}_{2} \frac{{E}_{l}}{{E}_{r}} )$$
and wherein Q is a quantization operator.

7. A method for selecting between MS encoding and LR encoding of an audio signal in a system having a left channel and a right channel, the method comprising:
computing four energy levels Eₗ₂, Eₗ₂, Eₘ₁ and Eₛ₁ defined as following:
$$\begin{matrix}{E}_{l 2} = {\sum }_{i ∈ band} \vert {x}_{i} [ i ] \vert \\ {E}_{r 2} = {\sum }_{i ∈ band} \vert {x}_{r} [ i ] \vert \\ {E}_{m 1} = {\sum }_{i ∈ band} \vert {x}_{l} [ i ] + {x}_{r} [ i ] \vert \\ {E}_{s 1} = {\sum }_{i ∈ band} \vert {x}_{r} [ i ] - {x}_{r} [ i ] \vert\end{matrix}$$
where xₗ[i] and xᵣ[i] respectively are the i-th samples of the audio signal corresponding to the left and right channels;
selecting the MS mode if (Eₗ₂+Eᵣ₂) is greater than
$$\frac{1}{\sqrt{2}} ( {E}_{m 1} + {E}_{s 1} ) ;$$
selecting the LR mode if (Eₗ₂+Eₗ₂) is less than
$$\frac{1}{\sqrt{2}} ( {E}_{m 1} + {E}_{s 1} ) .$$

8. A method for selecting between MS encoding and LR encoding of an audio signal in a system having a left channel and a right channel, the method comprising:
computing four energy levels Eₗ₂, Eᵣ₂, Eₘ₁ and Eₛ₁ defined as following:
$$\begin{matrix}{E}_{l 2} = {\sum }_{i ∈ band} \vert {x}_{i} [ i ] \vert \\ {E}_{r 2} = {\sum }_{i ∈ band} \vert {x}_{r} [ i ] \vert \\ {E}_{m 1} = {\sum }_{i ∈ band} \vert {x}_{l} [ i ] + {x}_{r} [ i ] \vert \\ {E}_{s 1} = {\sum }_{i ∈ band} \vert {x}_{r} [ i ] - {x}_{r} [ i ] \vert\end{matrix}$$
where xₗ[i] and xᵣ[i] respectively are the i-th samples of the audio signal corresponding to the left and right channels;
computing energy levels F₁ and F₂ defined as following:
F₁=(Eₗ₂+Eᵣ₂)
F₂=(Eₘ₁+Eₛ₁)
selecting the MS mode if 16×(F₁−F₂)+F₁+4×F₂ is greater than zero; and
selecting the LR mode if 16×(F₁−F₂)+F₁+4×F₂ is less than zero.

9. An apparatus configured to select an encoding mode of an audio signal in a multi-channel system, the apparatus comprising:
a module configured to determine energy level of audio signal associated with each of the channels;
a module configured to compute a first value defined by said energy levels;
a module configured to determine degree of correlation between the audio signal associated with each of the channels;
a module configured to compute a second value defined by said degree of correlation; and
a module configured to select a first mode of encoding if the first value is smaller than the second value.

10. The apparatus of claim 9 further comprising:
a module configured to compute a third value defined by said energies;
a module configured to compute a fourth value defined by said degree of correlation;
a module configured to select a second mode of encoding if the first value is greater than the second value, and the third value is smaller than the fourth value; and
a module configured to select a third mode of encoding if the first value is greater than the second value, and the third value is greater than the fourth value.

11. The apparatus of claim 10 wherein said multi-channel system includes two channels, wherein said first value is defined by (τ Eₗ Eᵣ) where τ is a programmable parameter and wherein energies Eₗ and Eᵣ associated with the left and right channels are defined by:
$${E}_{l} = {\sum }_{i ∈ band} {{x}_{l} [ i ]}^{2}$$
$${E}_{r} = {\sum }_{i ∈ band} {{x}_{r} [ i ]}^{2}$$
where xₗ[i] and xᵣ[i] respectively represent the i-th sample of the signals of the left and right channels, and wherein said second value is defined by the square of the cross-correlation of the signals of the left and right defined by:
$$C = {\sum }_{i ∈ band} {x}_{l} [ i ] {x}_{r} [ i ]$$
and wherein the IS mode of encoding is selected if C² is greater than (τ Eₗ Eᵣ).

12. The apparatus of claim 11 wherein said third value is defined by |Eₗ−Eᵣ| and wherein said fourth value is defined by 2|C|, wherein an MS mode of encoding is selected if 2|C| is greater than Eₗ−Eᵣ|, and wherein an LR mode of encoding is selected if 2|C| is smaller than |Eₗ−Eᵣ|.

13. The apparatus of claim 12 wherein the left and right channel signals xₗ₁ and xᵣ₁ are defined as following if the IS mode is selected:
$${x}_{l1} [ i ] = \{ \begin{matrix}a ( {x}_{l} [ i ] + {x}_{r} [ i ] ) & if C > 0 \\ a ( {x}_{l} [ i ] - {x}_{r} [ i ] ) & otherwise\end{matrix} \\ {x}_{r1} [ i ] = {bx}_{l1} [ i ]$$
wherein said parameters a and b are defined as:
$$a = \frac{1}{\sqrt{{E}_{l} + {E}_{r} + 2 \vert C \vert}} \times \sqrt{{E}_{l}}$$
$$b = {2}^{- \frac{1}{4} is\_position}$$
where parameter is_position is defined as:
$$is\_position = Q ( 2 {log}_{2} \frac{{E}_{l}}{{E}_{r}} )$$
and wherein Q is a quantization operator.

14. The apparatus of claim 12 wherein the left and right channel signals xₗ₁ and xᵣ₁ are defined as following if the IS mode is selected:
$${x}_{l1} [ i ] = \{ \begin{matrix}a ( {x}_{l} [ i ] + {x}_{r} [ i ] ) & if C > 0 \\ a ( {x}_{l} [ i ] - {x}_{r} [ i ] ) & otherwise\end{matrix} \\ {x}_{r1} [ i ] = {bx}_{l1} [ i ]$$
wherein said parameters a and b are defined as:
$$a = \frac{1}{\sqrt{{E}_{l} + {E}_{r} + 2 \vert C \vert}} \times \{ \begin{matrix}\sqrt{{E}_{r}} {2}^{\frac{1}{4} is\_position} & if {E}_{r} > {E}_{l} \\ \sqrt{{E}_{l}} & otherwise\end{matrix} \\ b = {2}^{- \frac{1}{4} is\_position}$$
where parameter is_position is defined as:
$$is\_position = Q ( 2 {log}_{2} \frac{{E}_{l}}{{E}_{r}} )$$
and wherein Q is a quantization operator.

15. An apparatus configured to select between MS encoding and LR encoding of an audio signal and having a left channel and a right channel, the apparatus comprising:
a module configured to compute four energy levels Eₗ₂, Eᵣ₂, Eₘ₁ and Eₛ₁ defined as following:
$${E}_{l2} = {\sum }_{i ∈ band} \vert {x}_{l} [ i ] \vert$$
$${E}_{r2} = {\sum }_{i ∈ band} \vert {x}_{r} [ i ] \vert$$
$${E}_{m1} = {\sum }_{i ∈ band} \vert {x}_{l} [ i ] + {x}_{r} [ i ] \vert$$
$${E}_{s1} = {\sum }_{i ∈ band} \vert {x}_{r} [ i ] - {x}_{r} [ i ] \vert$$
where xₗ[i] and xᵣ[i] respectively are the i-th samples of the audio signal corresponding to the left and right channels;
a module configured to select the MS mode if (Eₗ₂+Eᵣ₂) is greater than
$$\frac{1}{\sqrt{2}} ( {E}_{m1} + {E}_{s1} ) ;$$
and a module configured to compute the LR mode if (Eₗ₂+Eᵣ₂) is less than
$$\frac{1}{\sqrt{2}} ( {E}_{m1} + {E}_{s1} ) .$$

16. An apparatus configured to select between MS encoding and LR encoding of an audio signal and having a left channel and a right channel, the apparatus comprising:
a module configured to compute four energy levels Eₗ₂, Eᵣ₂, Eₘ₁ and Eₛ₁ defined as following:
$${E}_{l2} = {\sum }_{i ∈ band} \vert {x}_{l} [ i ] \vert$$
$${E}_{r2} = {\sum }_{i ∈ band} \vert {x}_{r} [ i ] \vert$$
$${E}_{m1} = {\sum }_{i ∈ band} \vert {x}_{l} [ i ] + {x}_{r} [ i ] \vert$$
$${E}_{s1} = {\sum }_{i ∈ band} \vert {x}_{r} [ i ] - {x}_{r} [ i ] \vert$$
where xₗ[i] and xᵣ[i] respectively are the i-th samples of the audio signal corresponding to the left and right channels;
a module configured to compute energy levels F₁ and F₂ defined as following:
F₁=(Eₗ₂+Eᵣ₂)
F₂=(Eₘ₁+Eₛ₁)
a module configured to select the MS mode if 16×(F₁−F₂)+F₁+4×F₂ is greater than zero; and
a module configured to select the LR mode if 16×(F₁−F₂)+F₁+4×F₂ is less than zero.
